(19) United States
(12) Patent Application Publication
(10) Pub. No.: US 2026/0154308 A1
(43) Pub. Date: Jun. 4, 2026

(54) TAILORED GRAPH RAG PIPELINE FOR LLM QUERIES

(71) Applicant: eBay Inc., San Jose, CA (US)

(72) Inventor: Vasu Negi, Georgetown, TX (US)

(21) Appl. No.: 18/968,252

(22) Filed: Dec. 4, 2024

(51) Int. Cl. G06F 16/334; G06F 16/3329

(52) U.S. Cl. CPC G06F 16/3344; G06F 16/3329

(57) ABSTRACT

Systems and methods are directed to optimizing large language model (LLM) query responses using graph Retrieval-Augmented Generation (RAG). A Graph RAG system generates a knowledge graph customized for a team based on data from one or more data sources maintained by the team. The knowledge graph is then stored for later use by a query system. The query system receives, from a client device, a query that requires context from the knowledge graph. The context is obtained from the knowledge graph on substantially real-time. The query system generates a prompt that includes the context and the query. The prompt triggers the LLM to provide a response to the query. The query system then causes display of the response on the client device.

### TECHNICAL FIELD

The subject matter disclosed herein generally relates to utilizing large language models (LLMs). Specifically, the present disclosure addresses systems and methods for optimizing LLM query responses using Graph Retrieval-Augmented Generation (RAG).

### BACKGROUND

Conventionally, when utilizing large language models (LLMs) such as OpenAI's ChatGPT, Microsoft's Gemini, or eBay's HubGPT, there is a significant reliance on fine-tuning processes these models undergo, which are tailored by the respective companies. Additionally, some organizations may employ Retrieval-Augmented Generation (RAG) techniques to supplement user queries with contextual data. Fine-tuning models have limitations like overfitting, high costs, and a static knowledge base that requires frequent re-training to stay current. Traditional RAG, though helpful for augmenting responses, lacks a structured approach to connect retrieved information, often leading to fragmented or contextually inconsistent answers. It also struggles with optimal source selection, risking the inclusion of outdated or non-authoritative information. These challenges make it difficult to achieve reliable, up-to-date responses.

### BRIEF DESCRIPTION OF THE DRAWINGS

FIG. 1 is a diagram illustrating an example network environment suitable for optimizing LLM query response using Graph Retrieval-Augmented Generation (RAG), according to example embodiments.

FIG. 2 is a diagram illustrating components of a Graph RAG system, according to example embodiments.

FIG. 3 is a diagram illustrating components of a query system, according to example embodiments.

FIG. 4 is a flowchart illustrating operations of a method for optimizing a LLM query response using Graph RAG, according to example embodiments.

FIG. 5 is a flowchart illustrating operations of a method for generating a knowledge graph using Graph RAG, according to example embodiments.

FIG. 6 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

The use of LLMs is prevalent. However, the biggest limitation is that the LLM does not have knowledge of a team's or organization's data unless it is specifically provided to the LLM, for example, with the prompt. The amount of data is always increasing for the team or organization. Thus, a user cannot simply provide the entire context (e.g., in a context window) as an input into a prompt. Doing so can cause many issues such as recall degradation. Typically, the LLM uses transformers which use attention mechanisms to give attention to certain pieces of data which make more sense for the LLM to retain compared to other content. As soon as the amount of content provided in the prompt increases, the LLM starts to miss a lot of data.

Further, it is not feasible to put everything, all the time, into the context window. As an example, suppose there are 1000 emails, and a user wants a summary of the last five emails from their director. If context is not provided, the LLM will not know what the query is about. However, providing all 1000 emails into the prompt is not always a good idea and may not even be possible.

Systems and methods solve the above technical issues by optimizing LLM query response using Graph Retrieval-Augmented Generation (RAG). Specifically, example embodiments establish and utilize a pipeline that constructs a customized Graph RAG system and generates knowledge graphs tailored to individual team environments. The system is designed to process and structure vast amounts of data from project directories and repositories (e.g., Wiki or similar web applications containing articles or documents, Github or other code repositories, Jira or other issue and task tracking systems) that encompass applications, codes, and documents maintained by a team. Using all this data, customized and localized knowledge graphs are generated that can reflect the latest developments and design patterns specific to a team's projects. Thus, all the aggregated data is stored in a structured form in graphs, which allows relevant context to be quickly fetched for the LLM. This customization ensures that insights and responses generated by the LLM are highly relevant and immediately applicable to the team's specific context. Additionally, the pipeline supports continuous integration of new data, allowing the knowledge graph to evolve in real-time with the team's project. This dynamic update capability is important for maintaining accuracy and relevance of the system, ensuring that the knowledge graph grows and adapts with the team.

The use of Graph RAG provides many advantages. First, it improves relevance by providing more structured, entity-level understanding and ensuring that retrieval is not just based on keywords or vectors (as in normal RAG systems) but also on relationships between entities. Secondly, Graph RAG provides contextual coherence because it can use the structure of the knowledge graph to connect retrieved documents in a meaningful way - understanding how different entities and documents are related. Thirdly, Graph RAG provides scalable retrieval by implementing graph traversal algorithms to explore relationships between documents. Finally, Graph RAG leverages the structured nature of graphs and captures relationships such as hierarchies, causality, and/or temporal links between entities.

Thus, example embodiments address the technical problem of obtaining accurate LLM query responses by providing a pipeline using Graph RAG technology that is specifically tailored for individual team settings within an organization. In particular, example embodiments allow each team to generate customized knowledge graphs using their Graph RAG system. These customized knowledge graphs can then be used to provide context (e.g., summary of information from the knowledge graph) that can be included in a prompt to the LLM. The context can be provided instead of all the documents or files from a team's data repository.

While example embodiments discuss application of the Graph RAG system to a team, it is noted that example embodiments are applicable to any entity or organization that wants to generate and use a customized knowledge graph tailored to their data to provide context to LLM queries.

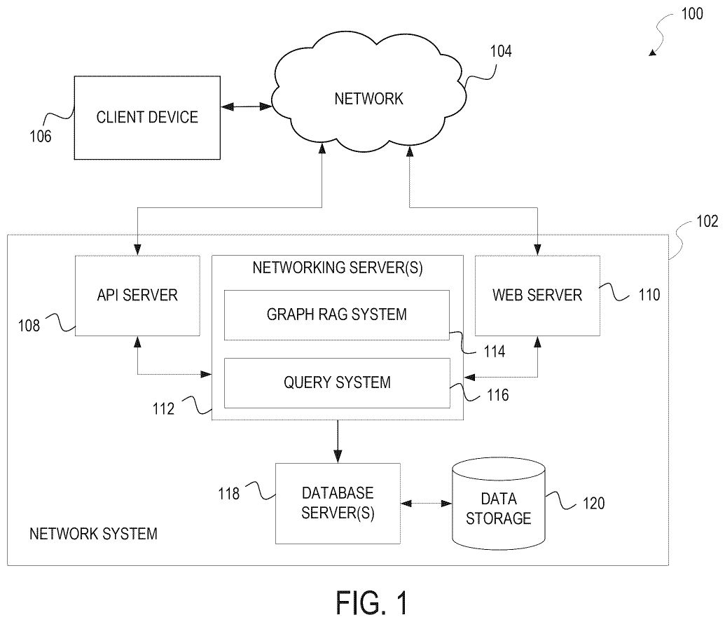

FIG. 1 is a diagram illustrating an example network environment 100 suitable for optimizing LLM query response using graph Retrieval-Augmented Generation (RAG), according to example embodiments. A network system 102 provides server-side functionality via a communication network 104 (e.g., the Internet, wireless network, cellular network, or a Wide Area Network (WAN)) to a client device 106. The network environment 100 is configured to receive data, queries, and instructions from the client device 106, process the data to generate knowledge graphs using Graph RAG, and generate and execute prompts that include context obtained from the generated knowledge graphs to answer the queries, as will be discussed in more detail below.

In various cases, the client device 106 is a device associated with a user of the network system 102 that is a member of a team that wants to build and/or use a knowledge graph customized to their team. The client device 106 can comprise one or more applications (not shown) that communicate with the network system 102 for added functionality. In one embodiment, the applications comprise a communication component that exchanges data with the network system 102. For example, the application can be a local version of an application or component of the network system 102. The application may be provided by the network system 102 and/or downloaded to the client device 106.

In example embodiments, the client device 106 interfaces with the network system 102 via a connection with the network 104. Depending on the form of the client device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

The client device 106 may comprise, but is not limited to, a smartphone, tablet, laptop, multi-processor systems, microprocessor-based or programmable consumer electronics, game consoles, or any other communication device that can access the network system 102. Additionally, the client device 106 comprises a display component (not shown) to display information (e.g., in the form of user interfaces) as will be discussed in more detail below. The client device 106 can be operated by a human user and/or a machine user.

Turning specifically to the network system 102, an application programing interface (API) server 108 and a web server 110 are coupled to and provide programmatic and web interfaces respectively to one or more networking servers 112. The networking server(s) 112 host various systems including a Graph RAG system 114 and a query system 116, each of which comprises a plurality of components and each of which can be embodied as hardware, software, firmware, or any combination thereof. The networking server(s) 112 are, in turn, coupled to one or more database servers 118 that facilitate access to one or more storage repositories or data storage 120. The data storage 120 is a storage device storing, for example, data associated with the team on the network system 102. For instance, the data storage 120 can comprise project directories and that encompass applications, code, and documents maintained by a team.

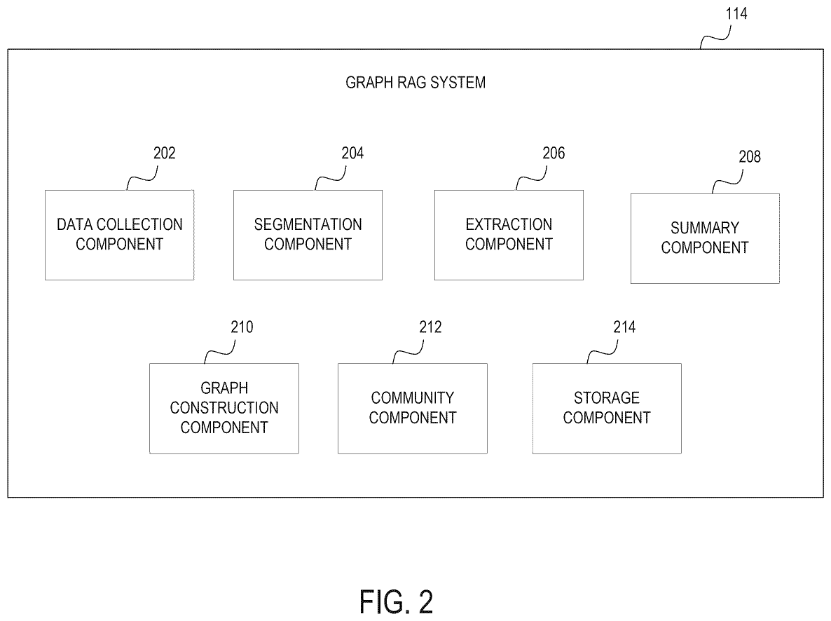

The Graph RAG system 114 is configured to generate one or more knowledge bases or knowledge graphs for an entity, project team, or organization. In example embodiments, the Graph RAG system 114 accesses data stored at the data storage 120 that is used to generate and update each knowledge graph. The generated knowledge graphs can also be stored to the data storage 120 for use by the query system 116. The Graph RAG system 114 will be discussed in more detail in connection with FIG. 2 below.

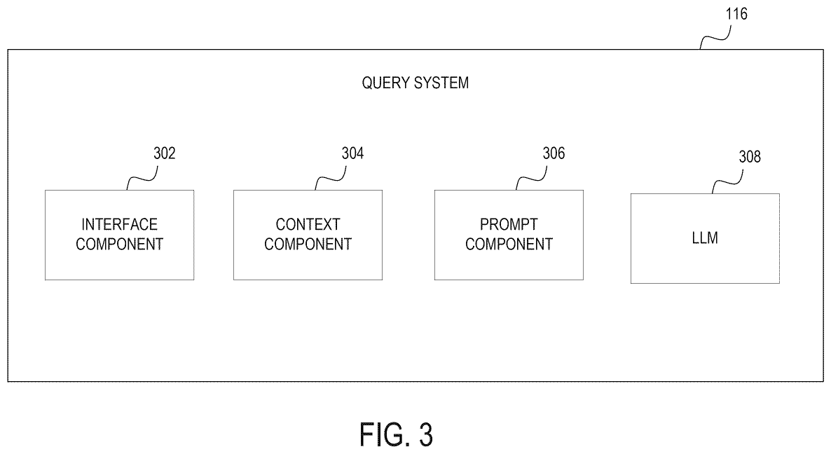

The query system 116 is configured to obtain context for a query from the knowledge graph and prompt an LLM to respond to a query using the context. The query system 116 will be discussed in more detail in connection with FIG. 3 below.

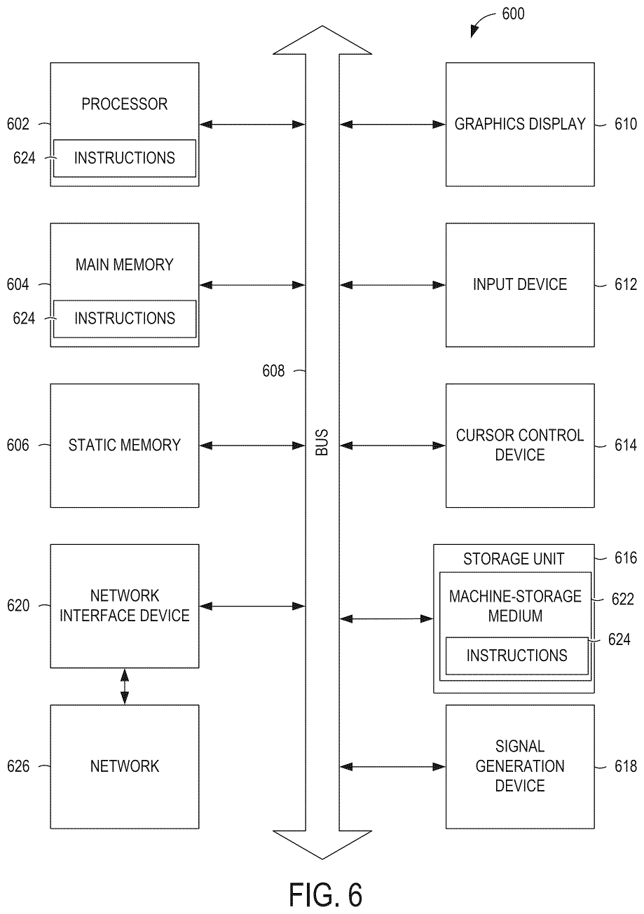

Any of the systems, data storage, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. For example, any of the functionalities discusses above with respect to the Graph RAG system 114 may be embodied within the query system 116 or vice-versa. Additionally, any number of client devices 106 and data storage 120 can be embodied within the network environment 100. While only a single network system 102 is shown, alternatively, more than one network system 102 can be included (e.g., localized to a particular region or division of an organization).

FIG. 2 is a diagram illustrating components of the Graph RAG system 114, according to example embodiments. The Graph RAG system 114 is configured to generate one or more knowledge bases or knowledge graphs for an entity, project team, or organization (collectively referred to herein as “team”) and to periodically update the knowledge graphs with current/relevant data. The knowledge graphs can then be used to derive context for a LLM query. To enable these operations, the Graph RAG system 114 comprises at least a data collection component 202, a segmentation component 204, an extraction component 206, a summary component 208, a graph construction component 210, a community component 212, and a storage component 214, which are communicatively coupled (e.g., via a bus). It is noted that some of the components of the Graph RAG system 114 can be located elsewhere in the network system 102 or network environment 100 and be communicatively coupled to the Graph RAG system 114.

The data collection component 202 is configured to access and collect data (e.g., source documents) specific to a team for which one or more knowledge graphs will be generated. In example embodiments, the data collection component 202 aggregates data (e.g., files) from all applications and documentation maintained by the team. For example, the data collection component 202 can access data or source documents associated with the team that is stored on the data storage 120 or data sources. The data sources can include, for example, a code repository (e.g., Github), a document repository that contains documents regarding team projects (e.g., Wiki containing WiKi pages), a resource/task management system (e.g., Jira), and/or any other type of data source that contains team-specific data.

Using the aggregated data, the segmentation component 204 segments the input corpus (e.g., each source document) into text chunks for processing by an LLM. For example, the text chunks can be paragraphs or sentences. By segmenting the source documents, detailed information from long documents can be preserved for analysis. For instance, the smaller the inputs to the LLM, the better retention of memory it has and yields more entity references. In contrast, if an entire source document is given to the LLM, the LLM will likely miss a lot of details. Granularity also imparts a number of LLM calls and recall precision. Larger chunks suffer from recall degradation. As such, segmentation or text chunking is performed.

The extraction component 206 is configured to extract elements from the text chunks, such as entities, relationships, and claims. In example embodiments, the extraction component 206 comprises or uses an LLM to extract this information. Entities can comprise people, places, and/or organizations, which can form nodes of the knowledge graph, while the relationships between the entities form the edges of the knowledge graph. The claims are key claims for each text chunk (e.g., facts). The extraction component 206 also extracts details such as name, type, and description for the entities and/or source, target entities, and a description of the connection for each extracted relationship.

In some embodiments, the extraction component 206 can be trained to generate prompts to extract the entities, relationships, and claims. For instance, general understanding of the work that is performed for a team or organization can be provided to the extraction component 206. The extraction component 206 consumes this understanding and can then automatically creates prompts tailored to the type of work.

In some embodiments, domain-specific fine tuning is used to tailor extraction to a specific domain for better extraction accuracy. When using the LLM to extract the elements, a prompt (e.g., generated by the extraction component 206) is provided that indicates to get all entities from each source document. The prompt can indicate what kind of entities to look for. For example, entities for legal documents (e.g., plaintiff, judges, defendants) are different from entities for technical documents (e.g., software engineer, project manager). In some cases, customized prompts specific to use cases and/or the team can be provided to the LLM.

In example embodiments, the extraction component 206 performs multiple extraction rounds to identify missed entities and relationships. That is, the extraction component 206 triggers the LLM to perform extraction of the elements more than once. This can ensure completeness and accuracy without introducing noise.

The summary component 208 is configured to perform domain-tailored summarization. The extraction(s) (e.g., of the elements extracted by the extraction component 206) can be used to produce instance-level summaries for each occurrence of an entity or relationship, and these instance-level summaries can be consolidated by the summary component 208 into single descriptive blocks for each graph element (e.g., entity node, relationship edge, claim covariate). As an example, suppose there are hundreds of documents about presidents and twenty talked about Ronald Reagan. During the extraction process, Reagan is extracted often. However, there may be some typos (e.g., Regan, Ragan). Because duplicates are not desired, these entities along with their summaries are merged into a single descriptive block in order to reduce the number of entities that are created. Each descriptive block can be represented using rich descriptive text. The rich descriptive text can talk about the entity and factual information (e.g., claims) gleaned from the source documents. Rich descriptive text along with each single descriptive block are consolidated into a node for each entity.

The graph construction component 210 is configured to build the knowledge graphs. In example embodiments, the merged entity nodes are positioned in the graph and connected via the relationships. For example, the graph construction component 210 can comprise or use Neo4J to build the knowledge graph, although any graph database management system can be used.

In example embodiments, the knowledge graph is modeled as a homogenous, undirected, weighted graph. The knowledge graph is undirected in that there is no direction between the entity nodes. Furthermore, the knowledge graph is weighted with some relationship edges between the entity nodes being more important than others. The weighting is based on a number of connections between two entity nodes (e.g., a normalized count of relationship instances). Normalization can be based on a total number of relationships found in the corpus, a total number of times the entities involved in the relationship appeared in the dataset, a frequency of other relationships in the knowledge graph, and/or a distribution of data (e.g., highly repeated instances do not overly skew results). The more connections, the more strongly related to each other they are. In some cases, the weight is represented by a numeric integer.

The community component 212 is configured to manage communities within the knowledge graph. In example embodiments, the community component 212 comprises or uses an algorithm to partition the knowledge graph into communities whereby entity nodes having stronger internal connections (e.g., more related) are clustered within a same community. In one embodiment, the Leiden Algorithm is used to determine the entity nodes that are strongly connected due to its efficiency in detecting hierarchical community structures in large-scale graphs.

After the communities are determined, the community component 212 performs hierarchical partitioning. In example embodiments, the community component 212 determines which communities are closer to each other and combines them into a higher-level community. Thus, for example, at the bottom of the hierarchy there may be a million entity nodes. Those entity nodes are combined into a thousand communities. Another level up, larger communities result from combining closely related smaller communities. There can be any number of levels (e.g., three or four levels). Each level of the hierarchy produces a mutually-exclusive, collective-exhaustive partition of entity nodes. Thus, each entity node in the knowledge graph belongs to a single community at each level of the hierarchy (e.g., is mutually exclusive), and all entity nodes are accounted for across all the communities (e.g., collective-exhaustive).

The community component 212 also creates report-like summaries for each community at each hierarchical level. The summaries provide an overview of the entire dataset in each community that provides useful context for future queries and comprise main entities, their relationships, and key claims. As such, these summaries provide an understanding of the global structure and semantics of the dataset. As an example, at the community level, community A will have information about all the nodes within the community. It can be very detailed, such as, node A talks about x, node B talks about y, and node A and node B are related in a particular way. This is done for all base level communities.

In some embodiments, the community component 212 summarizes nodes, edges, and covariates based on importance (e.g., most connected nodes first) until a token limit is reached. For instance, the community component 212 first identifies the most important connections between nodes (e.g., most connected). The community component 212 then adds descriptions for the most important nodes and their relationships. The community component 212 continues to add more information until it reaches a token limit (e.g., limit of how much text the LLM can handle).

A next hierarchical level up will summarize all the information about the lower-level communities contained within the higher-level community. Thus, the higher-level community has all the information about the lower-level communities, which internally has information about all their nodes. The summarization can continue with each higher-level until a top level is reach, whereby each higher-level summary contains all the information of the lower-community levels and nodes.

In example embodiments, each higher-level summary can be more “generic” than the summaries from which it was derived. In operation, if the whole summary for the higher-level community fits within the token limit, then all details are included. However, if the summary for the higher-level community is too large to fit in the context of all its smaller communities, the community component 212 takes the summaries of the smaller communities into the larger community and replaces the detailed descriptions with shorter summaries of those smaller communities. This provides a meaningful summary without going over the token limit.

The use of the hierarchies provides a technical advantage in obtaining the context. For example, if a very detailed answer is required, the question is not asked of the top-level community because it may only contain generic information (e.g., generic summary) for everything that is underneath it. Instead, the question can be asked of a lower level or possibly the base level where all entity nodes are located.

Once the knowledge graph is generated and communities determined, the storage component 214 stores the knowledge graph to a data storage (e.g., the data storage 120). The knowledge graph can then be queried to obtain context in real-time when a question is received from a user. The context can then be included in a prompt to answer the question.

The knowledge graph is constantly updated by the Graph RAG system 114 with new data, whereby the new data is processed (e.g., extract elements), summarized, incorporated into the knowledge graph, and associated with one or more communities. In some cases, the update is triggered manually by a user. In other cases, the update can be triggered based on an event (e.g., when an update to a code has been pushed, when a certain number of new documents added), based on an amount of time (e.g., every 10 days), or based on a combination of an event and time (e.g., it is has been 10 days and there are 10 new documents in the repository). Thus, the knowledge graph grows and adapts with the team and maintains its accuracy and relevance.

In some embodiments, the knowledge graph can be generated using all the data from the different data sources. For instance, the knowledge graph can be generated based on documents that contain project data (e.g., Wiki documents) and code from a code repository (e.g., code from GitHub) combined. This provides an advantage of not only being able to look into the code base, but also being able to refer to the project documentation which provides more contextual awareness.

In other embodiments, separate knowledge graphs can be generated for each data source. For example, a knowledge graph can be generated just based on code from the code repository and a separate knowledge graph can be generated from documents in a document repository (e.g., Wiki). During the context retrieval by the query system 116, the two knowledge graphs can be hot swapped.

FIG. 3 is a diagram illustrating components of the query system 116, according to example embodiments. The query system 116 is configured to obtain context for a query from the knowledge graph and prompt an LLM to response to a query using the context. In order to perform these operations, the query system 116 comprises an interface component 302, a context component 304, a prompt component 306, and a LLM 308.

The interface component 302 is configured to interface with the client device 106. In example embodiments, the interface component 302 receives a query or question from the client device 106, for example, via a user interface that is triggered by the interface component 302. The interface component 302 also provides the answer to the query back to the client device 106 via the user interface.

In example embodiments, the query asks a question that requires context from the knowledge graph to be accurately answered by the LLM 308. As such, the query is provided to the context component 304. The context component 304 is configured to obtain the context to be included in a prompt to the LLM 308 to answer the query. In example embodiments, there are two distinct querying workflows that each are designed for different types of queries. The first is a global search which is used for addressing broad, overarching questions about the entire data corpus by utilizing community summaries. The second is a local search which is focused on specific entities and expands outward to explore their connected neighbors and related concepts. As previously discussed, if a very detailed answer is required, the question is not asked of the top-level community because it may only contain generic information (e.g., generic summary) for everything that is underneath it. Instead, the question can be asked of a lower level or possibly the base level where all entity nodes are located.

There are several automated ways to determine which search type (e.g., global or local) and thus context to use. In one embodiment, the context component 304 automates the determination based on helpfulness scores. In this embodiment, the context component 304 triggers a query at each level (e.g., community level, base level) and assigns helpfulness scores to the community summaries for each level. The helpfulness score can indicate how helpful the community summary is for answering the query and can be an integer value from 0 to 100. In one embodiment, the LLM 308 is asked to evaluate the score for all the community summaries, and the community summary/summaries with the highest score can then be chosen as the final answer (e.g., the context to be included in the prompt). In some cases, the summaries are shuffled and divided into manageable chunks to spread relevant information evenly. Query-focused summarization answers with helpfulness scores can then be generated for each community. Low-scoring query-focused summarization answers can be filtered out, and the remaining query-focused summarization answers can be sorted by the helpfulness score. The highest scoring query-focused summarization answers can then be selected and merged (e.g., combined) into a final query-focused summarization answer that comprises the context to be used to answer the query.

In another embodiment, a token limit can be used. For the token limit, if information at a higher level exceeds the token limit, the context component 304 can select a lower level (or base level) to fit the summary.

In yet another embodiment, an algorithmic decision can be used. For the algorithmic decision, the context component 304 can analyze the query type to determine whether it is broad or specific and automatically select the appropriate level. In one embodiment, the context component 304 queries the LLM 308 with the query and the LLM 308 decides if the query is a broad or specific type.

In some embodiments, human decision can be involved. In one human decision embodiment, the interface component 302 can present the user with a choice between obtaining a detailed answer or an abstract answer to their query. A choice of an abstract answer will trigger a top-level community search, while a more detailed answer will trigger a lower-level search (e.g., lower-level community or base level with entity nodes). In a different human decision embodiment, an exploration process can be used. The context component 304 starts at a high-level community for a broad/abstract view and drills down into lower-level communities or even entity nodes for more details, if needed. For example, the context component 304 will use the summary for the highest-level community first and return a very brief understanding of the information. If the user decides the information is too high-level, the user can ask the query system 116 (e.g., the context component 304) the question again and the context component 304 can go to the next level down for more detailed summary and information.

In a further embodiment, a hybrid approach can be used to determine the search type. In the hybrid approach, the context component 304 can suggest a level based on automated evaluation to the user (e.g., via a user interface). The user can then refine or override the suggestion if they want to explore other levels.

Once the context is obtained by the context component 304, the context (e.g., summary) can then be provided to the LLM 308 in a prompt to answer the query. In example embodiments, the prompt component 306 generates the prompt based on the query and the context. The prompt component 306 then uses the prompt to trigger the LLM 308 to derive the answer to the query.

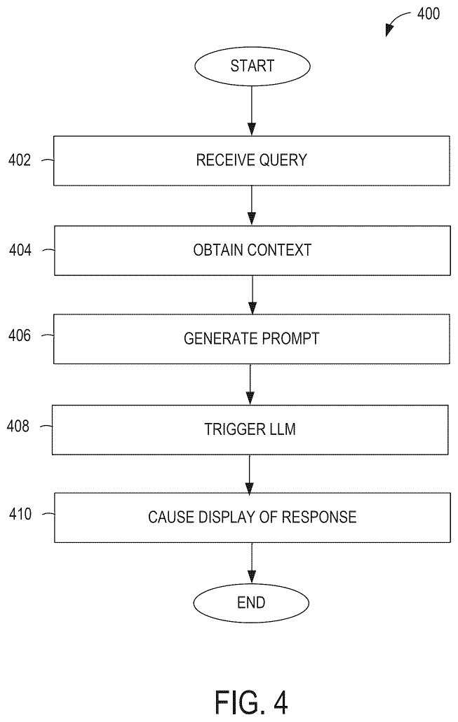

FIG. 4 is a flowchart illustrating operations of a method for optimizing a LLM query response using Graph RAG, according to example embodiments. Operations in the method 400 may be performed by the query system 116 using components described above with respect to FIG. 3. Accordingly, the method 400 is described by way of example with reference to the query system 116. However, it shall be appreciated that at least some of the operations of the method 400 may be deployed on various other hardware configurations or be performed by similar components residing elsewhere in the network environment 100. Therefore, the method 400 is not intended to be limited to the query system 116.

In operation 402, the query system 116 receives a query from a user. In example embodiments, the interface component 302 receives the query from the client device 106 via a user interface that is triggered by the interface component 302. The query can ask a question that requires context from one or more knowledge graphs that were previously generated.

In operation 404, the context component 304 obtains the context, in substantially real-time, to be included in a prompt to the LLM 308 to answer the query. In example embodiments, there can be different querying workflows based on different types of queries. For example, a global search can be used for addressing broad, overarching questions about the entire data corpus by utilizing community summaries, while a local search can be focused on specific entities and expands outward to explore their connected neighbors and related concepts.

There are several ways to determine which search type to use in determining the appropriate context. In some embodiments, the context component 304 automates the determination. In one automated embodiment, the context component 304 uses helpfulness scores whereby the context component 304 assigns helpfulness scores to the community summaries at each level. The community summary/summaries or level with the highest score can then be chosen as a final query-focused summarization (e.g., the context).

In another automated embodiment, a token limit can be used whereby if information at a higher level exceeds the token limit, the context component 304 can select a lower-level to fit the summary.

In a further automated embodiment, the context component 304 can analyze the query type (e.g., broad or specific based on wording within the query) and automatically select the appropriate community level (or base level) from which to retrieve the context.

In alternative embodiments, human decision can be involved. For example, the interface component 302 can present the user with a choice between obtaining a detailed answer or an abstract answer to their query. A choice of an abstract answer will trigger a top-level community search, while a more detailed answer will trigger a lower-level search (e.g., a lower-level community or base level at entity node). In a different example, an exploration process can be used, whereby the context component 304 starts at a high-level community for a broad/abstract view and drills down into lower-level communities (or even at the base-level entity node) for more details, if needed.

In further embodiments, a hybrid approach can be used to determine the search type. In the hybrid approach, the context component 304 can suggest a level based on automated evaluation and the user can then refine or override the suggestion.

In operation 406, the prompt component 306 generates a prompt based on the query. The prompt includes the context that was obtained in operation 404 along with the query (and/or instructions to answer the query using the context).

In operation 408, the prompt component 306 triggers the LLM 308 to derive the answer to the query. Because current context is provided in the prompt, the response will be fully aligned with the most current and relevant project-specific information for the team. The LLM 308 then responds with the response. The interface component 302 then causes display of the response in operation 410.

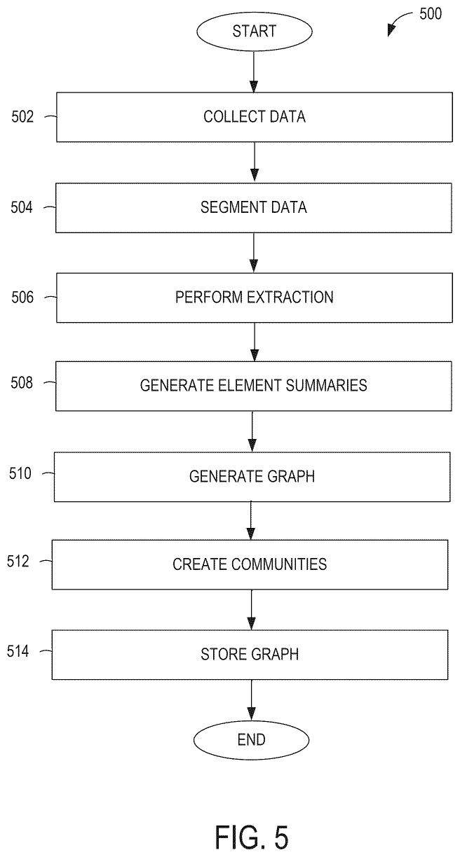

FIG. 5 is a flowchart illustrating operations of a method 500 for FIG. 5 is a flowchart illustrating operations of a method for generating a knowledge graph using Graph RAG, according to example embodiments. Operations in the method 500 may be performed by the Graph RAG system 114 using components described above with respect to FIG. 2. Accordingly, the method 500 is described by way of example with reference to the Graph RAG system 114. However, it shall be appreciated that at least some of the operations of the method 500 may be deployed on various other hardware configurations or be performed by similar components residing elsewhere in the network environment 100. Therefore, the method 500 is not intended to be limited to the Graph RAG system 114.

In operation 502, the data collection component 202 collects data to be used in generating the knowledge graph from all data sources or repositories maintained by (or associated with) a team. The data sources can include a code repository (e.g., Github), a document repository (e.g., Wiki containing Wiki pages), and/or a task data from a resource/task management system (e.g., Jira).

In operation 504, the segmentation component 204 segments the collected data into text chunks for processing. For example, the data or information can be segmented into smaller chunks of text. By segmenting the data, detailed information from long documents can be preserved for analysis.

In operation 506, the extraction component 206 performs extraction of elements from the text chunks. The elements can comprise entities, relationships, and claims. In example embodiments, the extraction component 206 comprises or uses an LLM (e.g., LLM 308) to extract the elements. The extraction component 206 can also extract details such as name, type, and description for each of the entities and/or source, target entities, and a description of the connection for each extracted relationship.

In order to extract the elements, the extraction component 206 can be trained to generate prompts to extract the features. In some embodiments, domain-specific fine tuning can be used to tailor extraction to a specific domain associated with the team. Thus, the extraction component 206 can generate a prompt that indicates what kinds of entities, relationships, and claims to look for. Multiple rounds of extraction can be performed to ensure that entities, relationships, and claims are not missed.

In operation 508, the summary component 208 generates element summaries. The extraction by the extraction component 206 produces instance-level summaries for each occurrence of an entity or relationship. These summaries are consolidated by the summary component 208 into single descriptive blocks for each graph element. These graph elements are then represented using rich descriptive text that can talk about the entity and factual information gleaned from the source documents. The rich descriptive text along with each single descriptive block can be consolidated into a node for the entity.

In operation 510, the graph construction component 210 generates the knowledge graph. In example embodiments, the merged entity nodes are positioned in the graph and connected via the relationships. In one example, the graph construction component 210 comprises or uses Neo4J to build the knowledge graph. In example embodiments, the knowledge graph is modeled as a homogenous, undirected, weighted graph.

In operation 512, the community component 212 creates communities within the knowledge graph. In example embodiments, the community component 212 uses an algorithm to partition the knowledge graph into communities whereby entity nodes having stronger internal connections (e.g., more related) are clustered within a same community. In one embodiment, the Leiden Algorithm is used to determine the entity nodes that are strongly connected due to its efficiency in detecting hierarchical community structures in large-scale graphs. These communities can be further clustered into larger communities resulting in a multi-level hierarchy.

Each community at each level will have a summary of all the nodes within its community. This allows different communities and levels of the hierarchy to be search for context based on depth of the query (e.g., generic or detailed).

In operation 514, the storage component 214 stores the knowledge graph to a data storage. The knowledge graph can then be accessed and queried for context in real-time when a query is received from a user.

In example embodiments, the knowledge graph is constantly updated with new data. The new data can be collected and segmented, have features extracted therefrom, have element summaries generated, and incorporated into the knowledge graph. The new data can also be associated with a community at each hierarchical level. In some cases, the update is triggered manually by a user. In other cases, the update can be triggered based on an event (e.g., when an update to a code has been pushed, when a certain number of new documents added), based on an amount of time (e.g., every 10 days), or based on a combination of an event and time (e.g., it is has been 10 days and there are 10 new documents in the repository). Thus, the knowledge graph grows and adapts with the team as, for example, team projects grow and change.

In some embodiments, the knowledge graph is generated from multiple different data sources. For instance, the knowledge graph can be generated based on documents that contain project data (e.g., Wiki documents) and code from a code repository (e.g., code from GitHub) combined.

In other embodiments, separate knowledge graphs can be generated for each data source. For instance, a first knowledge graph can be generated based on code from the code repository and a second knowledge graph can be generated from documents in a document repository. During context retrieval by the query system 116, the two knowledge graphs can be hot swapped.

FIG. 6 illustrates components of a machine 600, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagram of FIG. 4 and FIG. 5. In one embodiment, the instructions 624 can transform the machine 600 into a particular machine (e.g., specially configured machine) programmed to carry out the described and illustrated functions in the manner described.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more components described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-storage medium 622 (e.g., a tangible machine-storage medium) on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered as machine-storage media (e.g., tangible and non-transitory machine-storage media). The instructions 624 may be transmitted or received over a network 626 via the network interface device 620.

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### EXECUTABLE INSTRUCTIONS AND MACHINE—STORAGE MEDIUM

The various memories (e.g., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed embodiments.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 622 specifically exclude carrier waves, modulated data signals, and other such media, at least some of which are covered under the term “signal medium” discussed below. In this context, the machine-storage medium is non-transitory.

### SIGNAL MEDIUM

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### COMPUTER READABLE MEDIUM

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., TCP/IP). Examples of communication networks 626 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented components may be distributed across a number of geographic locations.

### EXAMPLES

Example 1 is a method for optimizing large language model (LLM) query responses using graph Retrieval-Augmented Generation (RAG). The method comprises generating, using Graph Retrieval Augmented Generation (RAG), a knowledge graph customized for a team based on data from one or more data sources maintained by the team; receiving, from a client device, a query that requires context from the knowledge graph; obtaining the context from the knowledge graph; generating a prompt that includes the context and the query; triggering, with the prompt, a large language model (LLM) to provide a response to the query; and causing display of the response on the client device

In example 2, the subject matter of example 1 can optionally include wherein the knowledge graph is customized for a team and the data is maintained by the team; generating the knowledge graph comprises collecting the data from the one or more data sources, the one or more data sources comprising two or more of a code repository storing code generated by the team, a document repository storing documents regarding projects of the team, or a resource/task management system providing tracking and reports on the projects; and the context is based on the data from the two or more code repositories..

In example 3, the subject matter of any of examples 1-2 can optionally include wherein generating the knowledge graph comprises segmenting the data from the one or more data sources into text chunks.

In example 4, the subject matter of any of examples 1-3 can optionally include wherein generating the knowledge graph further comprises extracting elements from the text chunks, the elements comprising entities, relationships, and claims; and the context for the prompt is based on the elements that are associated with the query.

In example 5, the subject matter of any of examples 1-4 can optionally include wherein generating the knowledge graph further comprises training an extraction component to generate a domain-specific prompt to extract the elements.

In example 6, the subject matter of any of examples 1-5 can optionally include wherein generating the knowledge graph further comprises generating element summaries for the extracted elements.

In example 7, the subject matter of any of examples 1-6 can optionally include generating a plurality of communities within the knowledge graph, each community comprising a cluster of closely-related entity nodes having strong internal connections and comprising a community summary that is based on element summaries of elements comprised within the respective closely-related entity nodes, the context for the prompt being based on the community summary.

In example 8, the subject matter of any of examples 1-7 can optionally include performing hierarchical partitioning to generate a multi-level hierarchy of communities, whereby closely related communities are clustered into a higher-level community, each higher-level community comprising a summary of its respective closely related communities.

In example 9, the subject matter of any of examples 1-8 can optionally include periodically updating the knowledge graph with new data from the one or more data sources.

In example 10, the subject matter of any of examples 1-9 can optionally include wherein generating the knowledge graph comprises generating a knowledge graph for each data source of the one or more data sources; and the knowledge graphs for two data sources are hot swapped during context retrieval.

In example 11, the subject matter of any of examples 1-10 can optionally include

wherein obtaining the context comprises generating query-focused summarization answers and assigning a helpfulness score to each query-focused summarization answer; and selecting and merging highest scoring query-focused summarization answers into a final query-focused summarization answer that is the context.

In example 12, the subject matter of any of examples 1-11 can optionally include wherein obtaining the context comprises causing presentation of a user interface requesting a user at the client device to indicate whether the response should be detailed or abstract; and based on an indication of abstract, performing a top-level community search or based on an indication of detailed, performing a lower-level community search.

In example 13, the subject matter of any of examples 1-12 can optionally include

wherein obtaining the context comprises performing a top-level community search; causing presentation of a brief understanding of information from the top-level community search on the client device; receiving an indication whether the information is too high-level; and based on the information being too high-level, continuing performing a search in a next level down until an indication that the information is at the correct level is received.

Example 14 is a system for optimizing large language model (LLM) query responses using graph Retrieval-Augmented Generation (RAG). The system comprises one or more processors and a memory storing instructions that, when executed by the one or more processors, cause the one or more processors to perform operations comprising

generating, using Graph Retrieval Augmented Generation (RAG), a knowledge graph customized for a team based on data from one or more data sources maintained by the team; receiving, from a client device, a query that requires context from the knowledge graph; obtaining the context from the knowledge graph; generating a prompt that includes the context and the query; triggering, with the prompt, a large language model (LLM) to provide a response to the query; and causing display of the response on the client device.

In example 15, the subject matter of example 14 can optionally include wherein generating the knowledge graph comprises segmenting the data from the one or more data sources into text chunks; and extracting elements from the text chunks, the elements comprising entities, relationships, and claims.

In example 16, the subject matter of any of examples 14-15 can optionally include wherein generating the knowledge graph further comprises generating element summaries for the extracted elements.

In example 17, the subject matter of any of examples 14-16 can optionally include wherein the operations further comprise generating a plurality of communities within the knowledge graph, each community comprising a cluster of closely-related entity nodes having strong internal connections.

In example 18, the subject matter of any of examples 14-17 can optionally include wherein the operations further comprise performing hierarchical partition to generate a multi-level hierarchy of communities, whereby closely related communities are clustered into a higher-level community.

In example 19, the subject matter of any of examples 14-18 can optionally include

wherein the operations further comprise periodically updating the knowledge graph with new data from the one or more data sources.

Example 20 is a computer-storage medium comprising instructions which, when executed by one or more processors of a machine, cause the machine to perform operations for optimizing large language model (LLM) query responses using graph Retrieval-Augmented Generation (RAG). The operations comprise generating, using Graph Retrieval Augmented Generation (RAG), a knowledge graph customized for a team based on data from one or more data sources maintained by the team; receiving, from a client device, a query that requires context from the knowledge graph; obtaining the context from the knowledge graph; generating a prompt that includes the context and the query; triggering, with the prompt, a large language model (LLM) to provide a response to the query; and causing display of the response on the client device.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
generating, using Graph Retrieval Augmented Generation (RAG), a customized knowledge graph based on data from one or more data sources;
receiving, from a client device, a query that requires context from the knowledge graph;
obtaining the context from the knowledge graph;
generating a prompt that includes the context and the query;
triggering, with the prompt, a large language model (LLM) to provide a response to the query; and
causing display of the response on the client device.

2. The method of claim 1, wherein:
the knowledge graph is customized for a team and the data is maintained by the team;
generating the knowledge graph comprises collecting the data from the one or more data sources, the one or more data sources comprising two or more of a code repository storing code generated by the team, a document repository storing documents regarding projects of the team, or a resource/task management system providing tracking and reports on the projects; and
the context is based on the data from the two or more code repositories.

3. The method of claim 1, wherein generating the knowledge graph comprises segmenting the data from the one or more data sources into text chunks.

4. The method of claim 3, wherein:
generating the knowledge graph further comprises extracting elements from the text chunks, the elements comprising entities, relationships, and claims; and
the context for the prompt is based on the elements that are associated with the query.

5. The method of claim 4, wherein generating the knowledge graph further comprises training an extraction component to generate a domain-specific prompt to extract the elements.

6. The method of claim 4, wherein generating the knowledge graph further comprises generating element summaries for the extracted elements.

7. The method of claim 1, further comprising:
generating a plurality of communities within the knowledge graph, each community comprising a cluster of closely-related entity nodes having strong internal connections and comprising a community summary that is based on element summaries of elements comprised within the respective closely-related entity nodes, the context for the prompt being based on the community summary.

8. The method of claim 7, further comprising:
performing hierarchical partitioning to generate a multi-level hierarchy of communities, whereby closely related communities are clustered into a higher-level community, each higher-level community comprising a summary of its respective closely related communities.

9. The method of claim 1, further comprising:
periodically updating the knowledge graph with new data from the one or more data sources.

10. The method of claim 1, wherein:
generating the knowledge graph comprises generating a knowledge graph for each data source of the one or more data sources; and
the knowledge graphs for two data sources are hot swapped during context retrieval.

11. The method of claim 1, wherein obtaining the context comprises:
generating query-focused summarization answers and assigning a helpfulness score to each query-focused summarization answer; and
selecting and merging highest scoring query-focused summarization answers into a final query-focused summarization answer that is the context.

12. The method of claim 1, wherein obtaining the context comprises:
causing presentation of a user interface requesting a user at the client device to indicate whether the response should be detailed or abstract; and
based on an indication of abstract, performing a top-level community search or based on an indication of detailed, performing a lower-level community search.

13. The method of claim 1, wherein obtaining the context comprises:
performing a top-level community search;
causing presentation of a brief understanding of information from the top-level community search on the client device;
receiving an indication whether the information is too high-level; and
based on the information being too high-level, continuing performing a search in a next level down until an indication that the information is at the correct level is received.

14. A system comprising:
one or more processors; and
a memory storing instructions that, when executed by the one or more processors, cause the one or more processors to perform operations comprising:
generating, using Graph Retrieval Augmented Generation (RAG), a knowledge graph based on data from one or more data sources;
receiving, from a client device, a query that requires context from the knowledge graph;
obtaining the context from the knowledge graph;
generating a prompt that includes the context and the query;
triggering, with the prompt, a large language model (LLM) to provide a response to the query; and
causing display of the response on the client device.

15. The system of claim 14, wherein generating the knowledge graph comprises:
segmenting the data from the one or more data sources into text chunks; and
extracting elements from the text chunks, the elements comprising entities, relationships, and claims.

16. The system of claim 15, wherein generating the knowledge graph further comprises generating element summaries for the extracted elements.

17. The system of claim 14, wherein the operations further comprise:
generating a plurality of communities within the knowledge graph, each community comprising a cluster of closely-related entity nodes having strong internal connections.

18. The system of claim 17, wherein the operations further comprise:
performing hierarchical partition to generate a multi-level hierarchy of communities, whereby closely related communities are clustered into a higher-level community.

19. The system of claim 14, wherein the operations further comprise:
periodically updating the knowledge graph with new data from the one or more data sources.

20. A machine-storage medium comprising instructions which, when executed by one or more processors of a machine, cause the machine to perform operations comprising:
generating, using Graph Retrieval Augmented Generation (RAG), a customized knowledge graph based on data from one or more data sources;
receiving, from a client device, a query that requires context from the knowledge graph;
obtaining the context from the knowledge graph;
generating a prompt that includes the context and the query;
triggering, with the prompt, a large language model (LLM) to provide a response to the query; and
causing display of the response on the client device.
